(19) United States
(12) Patent Application Publication
(10) Pub. No.: US 2012/0283039 A1
(43) Pub. Date: Nov. 8, 2012

(54) COMPOSITIONS OF DICARBOXYLIC ACID MODIFIED IONOMERS

(75) Inventor: JOHN CHU CHEN, Hockessin, DE (US)

(73) Assignee: E.I. DU PONT DE NEMOURS AND COMPANY, Wilmington, DE (US)

(21) Appl. No.: 13/287,204

(22) Filed: Nov. 2, 2011

Related U.S. Application Data
(60) Provisional application No. 61/409,674, filed on Nov. 3, 2010.

(51) Int. Cl. A63B 37/06; A63B 37/12; A63B 37/02; C08L 33/02; C08K 5/092

(52) U.S. Cl. 473/373; 524/321; 473/371; 473/374; 473/372

(57) ABSTRACT

Disclosed is a composition comprising, or produced from, a dicarboxylic acid-modified ionomer. Also disclosed are articles produced from the composition, such as golf balls. A particular multi-piece golf ball has an intermediate layer between the cover and the core, wherein the intermediate layer comprises the dicarboxylic acid-modified ionomer composition.

### CROSS-REFERENCE TO RELATED APPLICATION

This application claims priority from U.S. Patent Application Ser. No. 61/409,674, filed on Nov. 3, 2010, which is incorporated herein by reference in its entirety.

### FIELD OF THE INVENTION

The invention relates to compositions of dicarboxylic acid modified ionomers useful for preparing golf balls. In particular, golf ball mantles comprising the modified ionomer compositions are described.

### BACKGROUND OF THE INVENTION

Several patents and publications are cited in this description in order to more fully describe the state of the art to which this invention pertains. The entire disclosure of each of these patents and publications is incorporated by reference herein.

Premium golf balls include wound balls, two-piece balls and multilayered balls. Wound balls may have a spherical molded center, elastomeric thread-like material wound around the center, and either a thermoplastic or thermoset cover. Two-piece balls have a spherical molded core covered with a thin layer of thermoplastic or thermoset material. Multilayered balls have a spherical molded core, a cover, and one or more intermediate layers between the core and the cover.

Thermoplastic ionomers of copolymers of α-olefins, particularly ethylene, and C₃₋₈ α,β-ethylenically unsaturated carboxylic acids have found utility in golf ball components such as covers, and other applications. See, e.g., U.S. Pat. No. 3,264,272.

Ionomers have been modified with additional components to improve their properties. For example, U.S. Pat. No. 5,789,475 discloses ionomers based on ethylene/unsaturated carboxylic acid copolymers modified with from 0.5 to 15 weight percent adipic acid. The modified-ionomers have improved melt flow and melt processing behavior over unmodified ionomers having a comparable level of neutralization of acid groups present. Certain mechanical properties are improved, particularly stiffness, abrasion resistance and low temperature izod impact. U.S. Pat. No. 5,789,475 and related U.S. Pat. No. 5,973,046 describe the use of such compositions to prepare golf ball covers.

In golf balls it is increasingly common to use intermediate layers (“mantles” or “inner covers” or “outer cores”) to provide optimum velocity, spin, feel, and playability. The overall properties of a multilayer golf ball are dependent on the properties of the various layers and how they interact with each other. The properties needed in the intermediate layer are dependent on construction of the golf ball, including the type of cover and core compositions, the thickness of each layer and how each of the various layers are expected to contribute to the overall properties for a particular golf ball. Desirable properties of intermediate layers may include high resilience, high stiffness, and moisture barrier, and better player control of short approach shots and long drives.

Thus, it is desirable to prepare compositions suitable for use in a golf ball that provide a combination of these favorable properties.

### SUMMARY OF THE INVENTION

The invention provides a dicarboxylic acid-modified ionomer composition comprising, consisting essentially of, or prepared from:

(a) 59.5 to 94.5 weight %, based on the combination of (a), (b) and (c), of an E/W dipolymer, wherein E represents copolymerized units of ethylene, and W represents copolymerized units of a C₃ to C₈ α,β-ethylenically unsaturated carboxylic acid, wherein the amount of W is from about 2 to about 30 weight % of the E/W dipolymer, and wherein the weight average molecular weight (Mw) of the E/W dipolymer is in the range of 80,000 to 500,000 Daltons (Da);

(b) an amount of a dicarboxylic acid moiety that is the dicarboxylic acid or a salt thereof, wherein the dicarboxylic acid has the formula

(i) HOOC—(CH₂)ₙ—COOH where n is an integer from 2 to 6; or

(ii) HOOC—C₆H₄—COOH, referring to any isomer of benzene dicarboxylic acid;

such that the dicarboxylic acid moiety, calculated as free dicarboxylic acid, is present at a level of from 0.5 to 10 weight % of the combination of (a), (b) and (c); and

(c) 5 to 40 weight %, based on the combination of (a), (b) and (c), of at least one of

(iv) an E/X/Y terpolymer, wherein E represents copolymerized units of ethylene, X represents copolymerized units of a C₃ to C₈ α,β-ethylenically unsaturated carboxylic acid, and Y represents copolymerized units of a softening comonomer selected from the group consisting of vinyl acetate, alkyl acrylate and alkyl methacrylate; wherein the alkyl groups have from 1 to 8 carbon atoms; wherein the amount of X is from about 2 to about 30 weight % of the E/X/Y terpolymer, and the amount of Y is from about 3 to about 45 weight % of the E/X/Y terpolymer; and wherein the molecular weight (Mw) of the E/X/Y terpolymer is in the range of 80,000 to 500,000 Da; or

(v) an ethylene dicarboxylic random copolymer comprising copolymerized units of ethylene and copolymerized units of a dicarboxylic comonomer selected from the group consisting of cyclic anhydrides of C₄-C₈ unsaturated acids, monoesters of C₄-C₈ unsaturated acids having at least two carboxylic acid groups, diesters of C₄-C₈ unsaturated acids having at least two carboxylic acid groups, and mixtures thereof, wherein said second ethylene copolymer comprises from about 5 to about 15 weight % copolymerized units of the dicarboxylic comonomer, based on the weight of the random copolymer; or

(vi) a polyolefin graft copolymer comprising a trunk polymer comprising polyethylene, polypropylene, ethylene propylene copolymers, or a copolymer comprising copolymerized units of ethylene and copolymerized units of vinyl acetate, alkyl acrylate or alkyl methacrylate, wherein the alkyl groups have from 1 to 8 carbon atoms, and wherein the trunk copolymer is modified by grafting thereto cyclic anhydrides of C₄-C₈ unsaturated acids; or

(vii) an E/Z dipolymer, wherein E represents copolymerized units of ethylene and Z represents copolymerized units of acrylic acid or methacrylic acid; wherein the amount of Z is about 3 to about 25 weight % of the E/Z copolymer; and wherein the molecular weight (Mw) of the E/Z dipolymer is in the range of 2,000 to 30,000 Da; wherein

the combined acid moieties in (a), (b) and (c) are nominally neutralized to a level from about 30% to about 75% to form carboxylate salts comprising cations. Alkali metal, alkaline earth or transition metal cations are preferred.

Notable compositions are those wherein
the (c) component consists essentially of (c)(iv); or
the (c) component consists essentially of (c)(v); or
the (c) component consists essentially of (c)(vi); or
the (c) component consists essentially of (c)(vii);or
the (c) component comprises a mixture of (c)(iv) and (c)(vii).

The composition is useful for preparing golf balls, particularly for use in a golf ball comprising a cover, a core and at least one intermediate layer between the cover and the core wherein the intermediate layer comprises the composition.

The invention also provides a golf ball comprising a core, a cover, and at least one intermediate layer between the core and the cover, the intermediate layer comprising a dicarboxylic acid-modified ionomer composition comprising, consisting essentially of, or prepared from:

(a) 59.5 to 99.5 weight %, based on the combination of (a), (b) and (c) when present, of an E/W dipolymer, wherein E represents copolymerized units of ethylene, and W represents copolymerized units of a C₃ to C₈ α,β-ethylenically unsaturated carboxylic acid, wherein the amount of W is from about 2 to about 30 weight % of the E/W dipolymer, wherein the Mw of the E/W dipolymer is in the range of 80,000 to 500,000 Da;

(b) an amount of dicarboxylic acid moiety or salt thereof, wherein the dicarboxylic acid has the formula

(i) HOOC—(CH₂)ₙ—COOH where n is an integer from 2 to 6; or

(ii) HOOC—C₆H₄—COOH;

such that dicarboxylic acid moiety, calculated as free dicarboxylic acid, is present at a level of from 0.5 to 10 weight % of the combination of (a), (b) and (c) when present; and optionally

(c) 5 to 40 weight %, based on the combination of (a), (b) and (c) when present, of at least one of

(iv) an E/X/Y terpolymer, wherein E represents copolymerized units of ethylene, X represents copolymerized units of a C₃ to C₈ α,β-ethylenically unsaturated carboxylic acid, and Y represents copolymerized units of a softening comonomer selected from the group consisting of vinyl acetate, alkyl acrylate and alkyl methacrylate; wherein the alkyl groups have from 1 to 8 carbon atoms; wherein the amount of X is from about 2 to about 30 weight % of the E/X/Y terpolymer, and the amount of Y is from about 3 to about 45 weight % of the E/X/Y terpolymer; and wherein the weight average molecular weight (Mw) of the E/X/Y terpolymer is in the range of 80,000 to 500,000 Da; or

(v) an ethylene dicarboxylic random copolymer comprising copolymerized units of ethylene and copolymerized units of a dicarboxylic comonomer selected from the group consisting of cyclic anhydrides of C₄-C₈ unsaturated acids, monoesters of C₄-C₈ unsaturated acids having at least two carboxylic acid groups, diesters of C₄-C₈ unsaturated acids having at least two carboxylic acid groups, and mixtures thereof, wherein the ethylene dicarboxylic random copolymer comprises from about 5 to about 15 weight % copolymerized units of the dicarboxylic comonomer, based on the weight of the random copolymer; or

(vi) a polyolefin graft copolymer comprising a trunk polymer comprising polyethylene, polypropylene, ethylene propylene copolymers, or a copolymer comprising copolymerized units of ethylene and copolymerized units of vinyl acetate, alkyl acrylate or alkyl methacrylate, wherein the alkyl groups have from 1 to 8 carbon atoms, and wherein the trunk copolymer is modified by grafting thereto cyclic anhydrides of C₄-C₈ unsaturated acids; or

(vii) an E/Z dipolymer, wherein E represents copolymerized units of ethylene and Z represents copolymerized units of acrylic acid or methacrylic acid; wherein the amount of Z is about 3 to about 25 weight % of the E/Z copolymer; and wherein the Mw of the E/Z dipolymer in the range of 2,000 to 30,000 Da; wherein

the combined acid moieties in (a), (b) and (c) when present are nominally neutralized to a level from about 30% to about 75% to form carboxylate salts comprising alkali metal, alkaline earth or transition metal cations.

### DETAILED DESCRIPTION OF THE INVENTION

The following definitions apply to the terms as used throughout this specification, unless otherwise limited in specific instances. What follows “is” may be considered as definition.

The technical and scientific terms used herein have the meanings that are commonly understood by one of ordinary skill in the art to which this invention belongs. In case of conflict, the present specification, including the definitions herein, controls. Tradenames are in uppercase.

The terms “comprises,” “comprising,” “includes,” “including,” “containing,” “characterized by,” “has,” “having”, “produced from”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith.

The transitional phrase “consisting essentially of” limits the scope of a claim to the specified materials or steps and those that do not materially affect the basic and novel characteristic(s) of the claimed invention. Optional additives as defined herein, at levels that are appropriate for such additives, and minor impurities are not excluded from a composition by the term “consisting essentially of”.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

The term “or”, as used herein, is inclusive; that is, the phrase “A or B” means “A, B, or both A and B”. More specifically, a condition “A or B” is satisfied by any one of the following: A is true (or present) and B is false (or not present); A is false (or not present) and B is true (or present); or both A and B are true (or present). Exclusive “or” is designated herein by terms such as “either A or B” and “one of A or B”, for example.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

Unless stated otherwise, all percentages, parts, ratios, and like amounts, are defined by weight. Unless stated otherwise, Melt Index, (MI) was measured using ASTM D-1238 at 190° C., using a 2160 gram weight.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 18% of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such. “Dipolymer” refers to polymers consisting essentially of two monomers and “terpolymer” refers to polymers consisting essentially of three monomers.

Random ethylene copolymers are synthesized by random or direct copolymerization of ethylene and the particular comonomer or comonomers in a high-pressure free radical autoclave process in which the polymers are polymerized by adding all monomers simultaneously. Such processes are described in U.S. Pat. No. 4,351,931. This process provides mixtures of comonomers that react with each other to form the polymer chain to provide random copolymers having copolymerized units of all comonomers incorporated into the polymer backbone or chain, so that at least some of atoms from the comonomer(s) form part of the polymer backbone.

Graft copolymers are synthesized by appending or “grafting” a moiety as a pendant group on an already-formed polymer chain. The grafted comonomer is attached to non-terminal repeat units of an existing polymer chain in a step subsequent to formation of the polymer chain, often by a free radical reaction. In a graft copolymer, none of the atoms of the grafted group are incorporated into the backbone of the polymer chain. The term “trunk polymer” as employed herein includes polyolefins such as polyethylene, ethylene propylene copolymers, and polypropylene or the polymerization product of ethylene and at least one additional polymerizable monomer such as vinyl acetate, alkyl acrylate, alkyl methacrylate, etc. that are polymerized or copolymerized and subsequently grafted with an additional comonomer to provide a graft copolymer.

The compositions described herein include ethylene dipolymers or ionomers thereof and a dicarboxylic acid or salt thereof, and optionally additional polymeric components.

### Acid Copolymers

The ethylene acid copolymer components of the compositions described herein are “direct” or “random” acid copolymers.

They are preferably an α-olefin, particularly ethylene, α,β-ethylenically unsaturated carboxylic acid, preferably acrylic acid or methacrylic acid, copolymers, optionally containing a third softening monomer. “Softening” means that the polymer is made less crystalline.

The ethylene acid dipolymers used as component (a) of the blends described herein may be described as E/W dipolymers, including without limitation, ethylene/acrylic acid dipolymers and preferably ethylene/methacrylic acid dipolymers. Thus, W represents copolymerized residues of acrylic acid or methacrylic acid. The amount of W is from about 2 to about 30 weight %, based on the weight of the E/W copolymer.

These dipolymers have average molecular weight (Mw) in the range of 80,000 to 500,000 Daltons (Da), and preferably have melt indices (MI) measured using ASTM D-1238 at 190° C., using a 2160 gram weight from about 0.1 to about 600, or from about 25 to about 300, or from about 60 to about 250 g/10 min.

Preferably, the amount of W is from 8 to 25 weight % of the dipolymer.

Ethylene acid terpolymers or ionomers thereof may be included in the compositions described herein as component (c)(iv) and may be described as E/X/Y terpolymers where E represents copolymerized units of ethylene, X represents copolymerized units of a C₃₋₈ α,β-ethylenically unsaturated carboxylic acid, preferably acrylic acid or methacrylic acid, and Y represents copolymerized units of a softening comonomer selected from alkyl acrylate or alkyl methacrylate, wherein the alkyl groups have from 1 to 8 carbon atoms, or vinyl acetate. X is present in an amount of about 2 to about 30 (or about 2 to 25 or about 2 to 20, or about 5 to 25) weight % of the E/X/Y polymer, and Y is present in an amount of from 3 to 45 weight % of the E/X/Y copolymer.

Included are E/X/Y terpolymers in which X represents copolymerized units of acrylic acid and Y represents copolymerized units of an alkyl acrylate. In these E/X/Y terpolymers, Y is present in an amount from 3 to 45% of the E/X/Y terpolymer (preferably from a lower limit of 3 or 5 or more preferably 10, to an upper limit of 25, 30 or 45 weight %). Suitable terpolymers include without limitation ethylene/acrylic acid/methyl acrylate, ethylene/acrylic acid/ethyl acrylate, ethylene/acrylic acid/n-butyl acrylate, ethylene/acrylic acid/iso-butyl acrylate. Preferred terpolymers include ethylene/acrylic acid/n-butyl acrylate terpolymers.

Also included are E/X/Y terpolymers in which X represents copolymerized units of methacrylic acid and Y represents copolymerized units of an alkyl acrylate. In these E/X/Y terpolymers, Y is present in an amount from 3 to 45 weight % of the E/X/Y terpolymer (preferably from a lower limit of 3 or 5 or more preferably 10, to an upper limit of 25, 30 or 45 weight %). These terpolymers include without limitation ethylene/methacrylic acid/methyl acrylate, ethylene/methacrylic acid/ethyl acrylate, ethylene/methacrylic acid/n-butyl acrylate, and ethylene/methacrylic acid/iso-butyl acrylate, notably ethylene/methacrylic acid/n-butyl acrylate terpolymers.

Of note are E/X/Y terpolymers, wherein X (e.g. methacrylic acid or acrylic acid) is present in an amount from 5 to 20 weight % of the copolymer and Y (e.g. alkyl acrylate such as butyl acrylate) is present in an amount from 10 to 45 weight % of the copolymer.

These E/X/Y copolymers have Mw in the range of 80,000 to 500,000 Daltons and preferably have melt indices (MI) from about 0.1 to about 600, or from about 25 to about 300, or from about 60 to about 250 g/10 min. at 190° C. with a weight of 2160 g.

Methods of preparing ethylene acid copolymers such as E/W and E/X/Y copolymers are known. They may be prepared as described in U.S. Pat. No. 4,351,931. Ethylene acid copolymers also may be prepared in continuous polymerizers by use of “co-solvent technology” as described in U.S. Pat. No. 5,028,674.

Suitable acid copolymers are commercially available from E. I. DuPont de Nemours & Company of Wilmington, Del. (DuPont), under the trademark “Nucrel®”.

### Ionomers

Unmodified, melt processible ionomers may be prepared from acid copolymers described above by methods known in the art. By “unmodified”, it is meant that the ionomers are not blended with any material that has been added for the purpose of modifying the properties of the unblended ionomer. Ionomers include partially neutralized acid copolymers, particularly copolymers prepared from copolymerization of ethylene and acrylic acid or methacrylic acid. The unmodified ionomers may be neutralized to any level that does not result in an intractable (not melt processible) polymer that does not have useful physical properties. Preferably, about 15 to about 90%, more preferably about 50 to about 75% of the acid moieties of the acid copolymer are neutralized to form carboxylate groups. Suitable cations for the carboxylate groups include any cations that are stable under polymer processing conditions, for example ammonium cations and metal cations. Preferred cations include alkali metal cations, alkaline earth metal cations, transition metal cations, and combinations of two or more of these metal cations.

Cations useful in making the unmodified ionomers include lithium, sodium, potassium, magnesium, aluminum, calcium, barium, or zinc, or combinations of such cations. Sodium, lithium, zinc, magnesium or calcium cations, or mixtures thereof, are preferred.

Suitable ionomers are commercially available from DuPont, under the trademark “Surlyn®” and from the ExxonMobil Chemical Corporation of Houston, Tex., under the tradenames “Escor” and “Iotek”.

### Dicarboxylic Acids and Salts

Component (b) of the blends described herein is a dicarboxylic acid or salt thereof, including those having the formula:

(i) HOOC—(CH₂)ₙ—COOH where n is an integer from 2 to 6; or

(ii) HOOC—C₆H₄—COOH;

Suitable dicarboxylic acids of formula (i) include succinic acid, glutaric acid and adipic acid. Adipic acid is preferred. Suitable dicarboxylic acids of formula (ii) include any isomer of benzene dicarboxylic acid, such as phthalic acid, isophthalic acid and terephthalic acid. Terephthalic acid is preferred.

Preferably the dicarboxylic acid(s) are present in about 0.5 to about 10 weight % of the total weight of the composition, calculated as the amount of dicarboxylic acid added to the composition in non-neutralized or free-acid form.

Salts of the dicarboxylic acid may be used to prepare the blends. Cations of the dicarboxylic acid salts may be any of a wide variety, including the lithium, sodium, zinc, potassium, barium, bismuth, strontium, magnesium, aluminum or calcium salts of the organic acids. Sodium, lithium, magnesium or calcium cations, or mixtures thereof are preferred. Sodium or lithium adipate is preferred.

As known in the art, commercial grades of dicarboxylic acids may include a number of structurally different organic acids of varying lesser amounts. As used herein, unless otherwise specified in limited circumstances, a composition that comprises a named acid may also include other acids that are present in commercial grades of the named acid. Furthermore, when the transitional term “consisting essentially of” is applied to compositions that comprise a named acid, other acids that may be present in commercial grades of the named acid are not excluded from the composition.

While it may be useful for the dicarboxylic acids (and salts) to have a low volatility when being melt-blended with the acid copolymer or ionomer, volatility has been found to not be limiting when preparing blends with high nominal neutralization levels, particularly above 50%, such as 75%. It is preferred, however, that the dicarboxylic acid (or salt) be non-volatile and non-migratory. By non-volatile, it is meant that the acid does not evaporate or sublimate significantly at temperatures of melt blending of the acid with the acid copolymer. By non-migratory, it is meant that the acid does not bloom to the surface of the polymeric article under normal storage conditions at ambient temperatures.

### Process for Making the Ionomer Composition

The melt-processable, modified ionomer blends may be produced by heating a mixture of the carboxylic acid copolymer(s) or ionomer(s), the dicarboxylic acid(s) or salt(s) thereof, and, if necessary to achieve the desired neutralization level, at least one basic compound capable of neutralizing the combined acid moieties of the acid copolymer and the organic acid. For example, the components of the composition may be mixed by

(a) Melt-blending ethylene α,β-ethylenically unsaturated C₃₋₈ carboxylic acid copolymer(s) or ionomer(s) thereof as described above that are not neutralized to a level that renders them intractable (not melt-processable) with one or more dicarboxylic acids as described above or salts thereof, and concurrently or subsequently

(b) if necessary, adding an amount of a basic compound capable of neutralization of the acid moieties in the acid copolymer and in the organic acid that is sufficient to achieve nominal neutralization levels of greater than 30%, greater than 35%, greater than 45%, greater than 50%, to about 75%, or above, to provide carboxylate salts comprising an alkali metal cation, alkaline earth metal cation, or combinations of two or more of these metal cations.

This procedure need not employ an inert diluent such as a solvent. Treatment of acid copolymers and dicarboxylic acids with basic compounds in this way enables the compositions described herein to be neutralized to a level higher than that which would result in loss of melt processability and properties for the ionomer alone.

The acid copolymer(s) or unmodified, melt-processable ionomer(s) may be melt-blended with the dicarboxylic acid(s) or salt(s) and optionally other polymers as described in greater detail below in any manner known in the art. For example, a salt and pepper blend of the components may be made and then melt-blended in an extruder. The melt-processable, acid copolymer/dicarboxylic-acid-or-salt blend may be treated with the basic compound by methods known in the art, such as melt-mixing. For example, a Werner & Pfleiderer twin-screw extruder may be used to mix the acid copolymer and the dicarboxylic acid and treat with the basic compound at the same time. It is desirable that the mixing be conducted so that the components are intimately mixed, allowing the basic compound to neutralize the acidic moieties.

The amount of basic metal compound capable of neutralizing acidic groups in the acid copolymer and the dicarboxylic acid(s) may be determined by adding the stoichiometric amount of the basic compound calculated to neutralize a target amount of acid moieties in the acid copolymer and dicarboxylic acid(s) in the blend (herein referred to as “% nominal neutralization” or “nominally neutralized”). Thus, sufficient basic compound is made available in the blend so that, in aggregate, the indicated level of nominal neutralization could be achieved.

Suitable basic compounds include compounds of alkali metals, such as lithium, sodium or potassium, transition metal ions and/or alkaline earth metal and mixtures or combinations of such cations. They include formates, acetates, nitrates, hydrogen carbonates, carbonates, oxides, hydroxides or alkoxides of the ions of alkali metals, and formates, acetates, nitrates, oxides, hydroxides or alkoxides of the ions of alkaline earth metals and transition metals. Basic compounds with magnesium or calcium ions, such as the corresponding formate, acetate, hydroxide, oxide, alkoxide, etc.; including magnesium hydroxide, are of note.

It is desirable to run the blending/neutralization process with an extruder equipped with a vacuum port to remove any excess volatiles including moisture. Moisture may have a negative impact on subsequent molding operations in that excess moisture and volatiles may create unwanted foaming and voids in the molded article.

The basic compound(s) may be added neat to the acid copolymer or ionomer thereof and the dicarboxylic acid or salt thereof. The basic compound(s) may also be premixed with a polymeric material such as an acid copolymer, to form a “masterbatch” that may be added to the acid copolymer or ionomer thereof and the dicarboxylic acid or salt thereof. A notable masterbatch comprises about 40 to 60% of a copolymer of ethylene, acrylic acid or methacrylic acid, and optionally an alkyl acrylate wherein the alkyl group has from 1 to 4 carbon atoms; and about 40 to 60% of a basic compound as described above (e.g., Mg(OH)₂).

In addition to the E/W ethylene acid dipolymer and the dicarboxylic acid, the composition may also comprise additional polymeric components. The composition may contain an E/X/Y terpolymer or ionomer thereof (component (c)(iv)), as described above.

Alternatively, the composition may comprise component (c)(v), an ethylene dicarboxylate random copolymer comprising copolymerized units of ethylene and copolymerized units of a dicarboxylate comonomer selected from the group consisting of cyclic anhydrides of C₄-C₈ unsaturated acids, monoesters of C₄-C₈ unsaturated acids having at least two carboxylic acid groups, diesters of C₄-C₈ unsaturated acids having at least two carboxylic acid groups, and mixtures thereof.

Examples of suitable dicarboxylate comonomers include unsaturated anhydrides such as maleic anhydride, and itaconic anhydride; C₁-C₂₀ alkyl monoesters of 1,4-butenedioc acids (e.g. maleic acid, fumaric acid, itaconic acid and citraconic acid), including methyl hydrogen maleate, ethyl hydrogen maleate, propyl hydrogen fumarate, and 2-ethylhexyl hydrogen fumarate; and diesters of 1,4-butenedioc acids, including dimethyl maleate, diethyl maleate and dipropyl fumarate. Of these, maleic anhydride, ethyl hydrogen maleate and methyl hydrogen maleate are preferred. Maleic anhydride and ethyl hydrogen maleate are most preferred.

The ethylene dicarboxylate random copolymer may comprise about 0.3 to about 20 weight % copolymerized units of the dicarboxylate comonomer, based on the weight of the ethylene dicarboxylate random copolymer. Alternatively, the level of copolymerized units of the dicarboxylate comonomer is in the range of about 4 to about 20 weight %, or about 4 to about 15 weight %, or about 6 to about 15 weight %, or about 8 to about 12.5 weight %, based on the total weight of the copolymer.

The ethylene dicarboxylate random copolymer may be a dipolymer or a higher order copolymer, such as a terpolymer or tetrapolymer. Specific examples include ethylene/maleic acid monoester dipolymers (such as ethylene/ethyl hydrogen maleate dipolymer), ethylene/maleic acid monoester/methyl acrylate terpolymers, ethylene/maleic acid monoester/methyl methacrylate terpolymers, ethylene/maleic acid monoester/ethyl acrylate terpolymers, ethylene/maleic acid monoester/ethyl methacrylate terpolymers, ethylene/maleic acid monoester/n-butyl acrylate terpolymers and ethylene/maleic acid monoester/n-butyl methacrylate terpolymers.

A representative ethylene dicarboxylate random copolymer is a random copolymer having a melt index of about 0.3 to 100 grams/10 minutes measured using ASTM D-1238 at 190° C., using a 2160 gram weight, and consisting essentially of copolymerized ethylene and a monoalkyl ester of a 1,4-butenedioic acid in which the alkyl group of the ester has 1 to 6 carbon atoms. Preferably, the copolymer is a dipolymer of ethylene and about 4 to about 15 weight % of ethyl hydrogen maleate (an E/MAME copolymer). A specific polymer may comprise from about 8 to about 10 weight % of ethyl hydrogen maleate. Such copolymers are commercially available from DuPont under the tradename Fusabond®.

Terpolymers or tetrapolymers comprise comonomers in addition to the ethylene and dicarboxylate comonomer. Suitable additional comonomers may be selected from the group consisting of vinyl acetate, alkyl acrylates, such as methyl acrylate and butyl acrylate, and alkyl methacrylates, for example methyl methacrylate and n-butyl methacrylate. Preferably, when the ethylene dicarboxylate random copolymer is a higher order polymer such as a terpolymer, the combined comonomers other than ethylene are present in about 6 to about 30 weight % of the copolymer.

Ethylene/maleic anhydride/alkyl ester terpolymers are commercially available from Arkema under the tradename Lotader®, with maleic anhydride amounts of 0.3 to about 4 weight % and acrylic ester content of about 5 to 30 weight %, based on the total weight of the copolymer.

Ethylene/ethyl hydrogen maleate/alkyl ester terpolymers are also known. They include terpolymers with ethyl hydrogen maleate content of 0.5 to about 10 weight % and acrylic ester content of about 5 to 30 weight %, based on the total weight of the copolymer.

The ethylene dicarboxylate random copolymers may be synthesized as described in U.S. Pat. No. 4,351,931. Some examples of this type of ethylene/ester copolymer are described in U.S. Patent Application Publication 2005/0187315.

Alternatively, the composition may comprise component (c)(vi), a polyolefin graft copolymer comprising a trunk polymer comprising polyethylene, polypropylene, or a copolymer copolymerized units of ethylene and copolymerized units of vinyl acetate, alkyl acrylate or alkyl methacrylate; wherein the alkyl groups have from 1 to 8 carbon atoms, wherein the trunk copolymer is modified by grafting thereto cyclic anhydrides of C₄-C₈ unsaturated acids. A preferred anhydride is maleic anhydride. These maleic anhydride-grafted polymers (maleated polymers) are polymeric materials in which maleic anhydride is reacted with an existing polymer, often under free-radical conditions, to form anhydride groups appended to the polymer chain. They include maleated polyethylene, maleated polypropylene, maleated ethylene vinyl acetate copolymers, maleated ethylene methyl acrylate copolymers, maleated metallocene polyethylene, maleated ethylene propylene copolymers and maleated ethylene propylene diene copolymers.

The trunk polymers may be synthesized and subsequently grafted with maleic anhydride according to well-known procedures. Such graft copolymers are also commercially available from DuPont under the tradename Fusabond®.

Alternatively, the composition may comprise component (c)(vii), an E/Z dipolymer, wherein E represents copolymerized units of ethylene and Z represents copolymerized units of acrylic acid or methacrylic acid; wherein the amount of Z is about 3 to about 25 weight % of the E/Z copolymer; and wherein the Mw of the E/Z dipolymer in the range of 2,000 to 30,000 Da.

These low molecular weight copolymers are preferably direct or random copolymers having a molecular weight (Mw) of about 2,000 to about 30,000 Da. Preferably they have polydispersities (Mw/Mn) of about 1 to about 10, more preferably about 1 to about 6. They are copolymers of ethylene and a C₃₋₈ α,β-ethylenically unsaturated carboxylic acid, preferably acrylic or methacrylic acid. Also preferably, the amount of copolymerized acid residues in these copolymers is about 3 to about 30 (or 5 to 20, or 3 to 15, most preferably 5 to 10) weight %, based on the total weight of the low molecular weight copolymer.

These low molecular weight copolymers also may be referred to as acid copolymer waxes. Suitable examples are commercially available from Honeywell Specialty Wax and Additives of Morristown, N.J. (e.g., AC540, believed to be an ethylene/5 weight % acrylic acid copolymer with a number average molecular weight (Mn) of 4369 Daltons, and others indicated in Table A with their molecular weights).

These low molecular weight polymers are typically too low in viscosity at elevated temperatures to have a meaningful or measurable melt index. Instead, their molecular weights may be correlated to their Brookfield viscosity. This technique for measuring viscosity of fluids is outlined in, for example, ASTM D2196, D2983 or D3236-1978. The Brookfield viscosity is reported in centipoise and the value is determined by the type of spindle and the spindle speed or shear rate at which the Brookfield Viscometer is operated. Brookfield Viscosity data (measured at 140° C.) in Table A were provided by Honeywell or by its predecessor, the Allied Signal Corporation.

TABLE A

| | | | Brookfield | | | Polydis- |
|---|---|---|---|---|---|---|
| | Trade | Composi- | Viscosity | Mn | Mw | persity |
| | Designation | tion | (cps) | (10³) | (10³) | (Mw/Mn) |
| LC-1 | AC143 | E/17AA | NA | NA | 2.04 | NA |
| LC-2 | AC540 | E/5AA | 575 | 4.3 | 7.5 | 1.7 |
| LC-3 | AC580 | E/10AA | 650 | 4.8 | 26.0 | 5.4 |
| LC-4 | AC5120 | E/15AA | 650 | 3.0 | 5.2 | 1.7 |

### Other Components

The compositions may additionally comprise small amounts of optional materials including additives for use in polymeric materials. Examples of suitable additives include, without limitation, fillers, plasticizers, stabilizers including viscosity stabilizers and hydrolytic stabilizers, primary and secondary antioxidants such as for example IRGANOX® 1010, ultraviolet ray absorbers and stabilizers, anti-static agents, dyes, pigments or other coloring agents, fire-retardants, lubricants, processing aids, slip additives, release agents, and/or mixtures thereof. Additional optional additives may include TiO₂, which is used as a whitening agent; optical brighteners, surfactants, and other components known in the art of golf ball manufacture to be useful but which may not be critical to golf ball performance and/or acceptance. Many such additives are described in the Kirk Othmer Encyclopedia of Chemical Technology, 5^{th} edition, John Wiley & Sons (Hoboken, N.J. 2005).

These additives may be present in the compositions in quantities that may be from 0.01 to 15%, preferably from 0.01 to 10%, or from 0.01 to 5% of the total composition, so long as they do not detract from the basic and novel characteristics of the composition and do not significantly adversely affect the performance of the composition or golf ball prepared from the composition, particularly high stiffness and high resilience.

The optional incorporation of such conventional ingredients into the compositions may be carried out by any known process, for example, by dry blending, by extruding a mixture of the various constituents, by the conventional masterbatch technique, or the like.

Examples of fillers include metals such as titanium, tungsten, aluminum, bismuth, nickel, molybdenum, iron, steel, lead, copper, brass, boron, boron carbide whiskers, bronze, cobalt, beryllium, zinc, tin, metal oxides including zinc oxide, iron oxide, aluminum oxide, tin oxide, titanium oxide, magnesium oxide, zinc oxide and zirconium oxide, as well as other well known corresponding salts and oxides thereof. Other commonly used fillers include barium sulfate, lead silicate, tungsten carbide, limestone (ground calcium/magnesium carbonate), zinc sulfate, silica, calcium carbonate, zinc carbonate, barium carbonate, clay, tungsten, and mixtures of any of these.

When fillers have been used in a particular composition, the coefficient of restitution (COR), as described below, decreased roughly proportionally to the volumetric displacement of the polymer by the filler. For example, if 5 volume % of filler is used to provide a desired specific gravity, then the COR of a sphere made from a filled composition may be about 95% of the COR of a comparable sphere made from the unfilled composition.

The compositions described herein may be injection molded or compression molded into various shaped articles, including covers or preferably intermediate layers for golf balls as described below.

### Properties

The compositions described herein have Shore D hardness of 35 to 65, 40 to 60, 45 to 60, or 45 to 55, when measured on standardized test plaques. They have flexural modulus of 35 to 100 kpsi, 40 to 95 kpsi, 45 to 90 kpsi, 55 to 90 kpsi, 60 to 90 kpsi, 70 to 90 kpsi or 75 to 85 kpsi, when measured on standardized test plaques.

Coefficient of restitution (COR₁₂₅) may be measured by firing a sphere that is 1.50 to 1.68 inches in diameter at an initial velocity of 125 feet/second against a steel plate positioned 3 feet from the point where initial velocity is determined and dividing the velocity of rebound from the plate by the initial velocity. One may also measure COR at several initial velocities, develop a correlation and determine a COR at a specified initial velocity based on the correlation. COR may be determined on a sphere prepared from a single composition or a sphere having two or more layers (for example, a finished golf ball). One skilled in the art recognizes that COR cannot be greater than 1.0.

For a solid test sphere prepared from a single composition, the COR may depend on a variety of characteristics of the composition, including its hardness. Often it is the case with ionomers that harder resins exhibit higher COR values. COR of the test spheres described herein when tested at 125 ft/second speed ranges from 0.500 to 0.850, 0.550 to 0.800, 0.600 to 0.800, 0.650 to 0.800, 0.650 to 0.750, or 0.700 to 0.750.

### Golf Ball Construction

The composition described herein may be used with any type of ball construction. It may be used in the cover or one or more intermediate layers of a golf ball. It is particularly useful for preparing golf balls with mantles or intermediate layers comprising the composition, providing such layers with improved player control in short approach shots and long drives.

Suitable golf ball constructions, including one-piece golf balls, two-piece golf balls, three-piece golf balls and multi-piece golf balls, are described in US2009/0118040 and in the references cited therein. The composition described herein may be used in any of the golf balls in which the compositions described in these applications can be used. Of note, however, are golf balls comprising a cover prepared from a polyurethane or polyurea composition, and an intermediate layer prepared from the composition as described herein; golf balls comprising a cover prepared from an ionomer composition other than the composition, including an organic acid modified ionomer composition, and an intermediate layer prepared from the composition as described herein.

Also noted are multi-piece golf balls having:

1. a core made of any composition (including thermoset compositions such as polybutadiene rubber), with or without filler, with an intermediate layer comprising the composition described herein;

2. a cover prepared from a polyurethane composition, and a core made of any composition, and at least one additional intermediate layer prepared from the composition described herein; and

3. a cover prepared from an ionomer composition, and a core made of any composition, and at least one additional intermediate layer prepared from the composition described herein.

Furthermore, properties such as hardness, modulus, compression, resilience, core diameter, intermediate layer thickness and cover thickness of golf balls have been found to affect play characteristics such as spin, initial velocity and feel of golf balls. Depending on the construction and desired characteristics of the golf ball, the core, intermediate layers, and cover may have different resilience, compression or hardness to achieve desired performance characteristics. The compositions described herein may be useful in preparing golf balls with resilience, compression or hardness gradients within a golf ball. The selection of materials for performance based on these criteria is also described at length in US2009/0118040 and US2009/0325733 and in the references cited therein.

In particular, the golf balls with an intermediate layer prepared from the composition described herein are characterized by straighter drives and better feel and control in short approach shots.

The thermoplastic compositions described herein may be useful in a wide range of objects other than mantles or intermediate layers of golf balls. For example, the compositions may be used as cores for balls other than golf balls.

The following examples are provided to describe the invention in further detail. These examples, which set forth a preferred mode presently contemplated for carrying out the invention, are intended to illustrate and not to limit the invention.

### EXAMPLES

### Materials Used

ION-1: an ethylene/methacrylic acid dipolymer with 15 weight % MAA, nominally neutralized to 59 mole % with sodium cations, with MI of 0.93 g/10 minutes.
ION-2: an ethylene/methacrylic acid dipolymer with 19 weight % MAA, nominally neutralized to 45 mole % with sodium cations, with MI of 4.5 g/10 minutes.
HC-1: an ethylene/methacrylic acid/n-butyl acrylate terpolymer with 9 weight % MAA, and 23.5 weight % nBA, with MI of 25 g/10 minutes.
HC-10: an ethylene/methacrylic acid dipolymer with 9 weight % MAA, with MI of 4.5 g/10 minutes.
LC-2: Honeywell AC540 as summarized in Table A.
BMI-1: A blend of 87.2 weight % of HC-1 and 9.7 weight % LC-2 (90:10 blend ratio) was neutralized on a single screw extruder with 3.1 weight % of a masterbatch concentrate of 55 weight % of HC-10 and 45 weight % ZnO to prepare BMI-1, nominally neutralized to 34 mole % to form carboxylate salts with zinc cations, with MI of 4.5 g/10 minutes.
Adipic acid: available commercially under the tradename Adi-pure® from Invista S.ar.l. of Wilmington, Del.

### Methods

### Test Procedures

Melt Index (MI) was measured using ASTM D-1238 at 190° C., using a 2160 gram weight. Hardness was measured using ASTM D-2240. Tensile Strength, elongation and tensile modulus were measured using ASTM D-882. Flexural Modulus was measured using ASTM D-790.

General extrusion conditions for making the blends identified in Table 2 are shown in Table 1. A Werner and Pfleiderer (Ramsey, N.J.) ZSK-30 co-rotating twin screw extruder with 13 barrels and 12 heated zones equipped with a high work screw was utilized to process these blends. Polymer pellets and additional components were fed from feeders at the rear of the extruder.

TABLE 1

| | Zone 1 | Zone 2 | Zones 3-13 | Die | Melt |
|---|---|---|---|---|---|
| Temperature ° C. | 65-77 | 123-180 | 177-250 | 189-250 | 200-260 |
| Vacuum inches | 27-28 | Screw | 200 | Total | 18-21 |
| | | Speed rpm | | rate | |
| | | | | (lb/h) | |

For the compositions in Table 2, the amount of each component is reported as weight % of the Example composition. Example 1 was prepared by blending ION-1 with adipic acid. Examples 2 to 7 were prepared by blending the Example 1 composition with BMI-1. Example 8 was prepared by blending ION-2 with adipic acid. Examples 2 to 7 were prepared by blending the Example 8 composition with BMI-1. Example 1A was prepared by blending ION-1 with adipic acid. Examples 16 and 17 were prepared by blending the Example 1A composition with additional ION-1. Example 15 was prepared by blending ION-2 with adipic acid. Examples 18 and 19 were prepared by blending the Example 1A composition with additional ION-2.

TABLE 2

| | | | Adipic | | | |
|---|---|---|---|---|---|---|
| Example | ION-1 | ION-2 | acid | Example 1 | Example 8 | BMI-1 |
| 1 | 95 | | 5 | | | |
| 2 | | | | 85 | | 15 |
| 3 | | | | 75 | | 25 |
| 4 | | | | 60 | | 40 |
| 5 | | | | 50 | | 50 |
| 6 | | | | 40 | | 60 |
| 7 | | | | 30 | | 70 |
| C1 | 100 | | | | | |
| C2 | | | | | | 100 |
| 8 | | 95 | 5 | | | |
| 9 | | | | | 85 | 15 |
| 10 | | | | | 75 | 25 |
| 11 | | | | | 60 | 40 |
| 12 | | | | | 50 | 50 |
| 13 | | | | | 40 | 60 |
| 14 | | | | | 30 | 70 |
| C3 | | 100 | | | | |

| | | | Adipic | |
|---|---|---|---|---|
| Example | ION-1 | ION-2 | Acid | Example 1A |
| 1A | 95 | | 5 | |
| 15 | 40 | | | 60 |
| 16 | 70 | | | 30 |
| 17 | | 92.5 | 7.5 | |
| 18 | | 33 | | 67 |
| 19 | | 60 | | 40 |

The compositions were characterized by measuring their melt index, as summarized in Table 3.

TABLE 3

| | MI |
|---|---|
| Example | (g/10 min) |
| 1 | 47 |
| 2 | 48 |
| 3 | 47 |
| 4 | 49 |
| 5 | 51 |
| 6 | 45 |
| 7 | 45 |
| C1 | 0.93 |
| 8 | 47 |
| 9 | 34 |
| 11 | 27 |
| 12 | 24 |
| 13 | 21 |
| 14 | 18 |
| C2 | 4.5 |
| 1A | 16.9 |
| 15 | 6 |
| 16 | 2.7 |
| 17 | 128 |
| 18 | 63.6 |
| 19 | 19.7 |
| C3 | 4.5 |

The compositions were injection molded into standard flex bars and tested for flex modulus according to ASTM D790, Method 1, Procedure A, employing a 3-point test fixture with a 2-inch span length and a crosshead speed of 0.50 inches/minute on standard flex bars. The method provides a measurement of the Tangent Modulus of Elasticity (3-Point Flex Modulus). The samples were also tested for Shore hardness, Shore C according to ASTM D2240-C and Shore D according to ASTM D2240-D. The results are summarized in Table 4.

TABLE 4

| Example | Flex modulus, kpsi | Shore D hardness | Shore C hardness |
|---|---|---|---|
| 1 | 40.1 | 50 | 78 |
| 2 | 25.4 | 45 | 73 |
| 3 | 19.5 | 42 | 70 |
| 4 | 12.5 | 38 | 63 |
| 5 | 10.2 | 36 | 58 |
| 6 | 9.5 | 33 | 58 |
| 7 | 8 | 30 | 54 |
| C1 | 64.1 | 61 | 91 |
| C2 | 6 | 31 | 56 |
| 8 | 66.8 | 59 | 88 |
| 9 | 53 | 56 | 86 |
| 10 | 48.5 | 54 | 84 |
| 11 | 42.3 | 50 | 80 |
| 12 | 33.8 | 47 | 76 |
| 13 | 26.9 | 44 | 73 |
| 14 | 18.1 | 40 | 67 |
| C3 | 92 | 64 | 93 |
| 1A | 39.6 | 54 | 81 |
| 15 | 66.8 | 60 | 87 |
| 16 | 70 | 62 | 88 |
| 17 | 35.6 | 53 | 78 |
| 18 | 64.3 | 60 | 86 |
| 19 | 92.9 | 64 | 91 |

### Thermoplastic Spheres

The compositions were molded into spheres 1.53 to 1.55 inches in diameter. For example but not limitation, injection molding conditions may include temperatures, pressures and cycle times as indicated in Table 5.

TABLE 5

| | Temp | Injection Pressure | |
|---|---|---|---|
| | (° C.) | (mPa) | Cycle Times (sec) |
| Melt | 150-260 | Packing 25-180 | Filling and Packing 40-90 |
| Mold | 10-30 | Hold 5-15 | Hold 15-30 |
| Front/Back | | | Cooling Time 50-100 |
| | | | Screw Retraction 5-50 |

The spheres were tested for hardness. As used herein, “Shore D hardness” of a material was measured generally in accordance with ASTM D-2240, with a one-second delay, on the curved surface of the molded sphere, four weeks after molding. The average hardness of three spheres of each composition is reported in Table 6.

TABLE 6

| | Hardness, |
|---|---|
| Example | Shore D |
| 1 | 54 |
| 2 | 49.1 |
| 3 | 46.1 |
| 4 | 42.3 |
| 5 | 39.8 |
| 6 | 37.3 |
| 7 | 35.5 |
| C1 | 61.4 |
| 8 | 59.3 |
| 9 | 56.2 |
| 10 | 53.4 |
| 11 | 46.3 |
| 12 | 50.1 |
| 13 | 45.2 |
| 14 | 40.4 |
| C2 | 30.7 |
| 1A | 59.3 |
| 15 | 63.1 |
| 16 | 64.7 |
| 17 | 58.2 |
| 18 | 61.9 |
| 19 | 64.4 |
| C3 | 63.9 |

Three spheres of each composition were tested for Atti (PGA) Compression. Atti Compression was measured using an “Atti” testing device according to standard procedures for that instrument. For accurate comparison of compression data, the diameter of the balls was corrected to 1.68 inch diameter using accepted methods, such as shimming. The results are summarized in Table 7 as an average.

COR was measured by firing the injection-molded spheres from an air cannon at several velocities over a range of roughly 100 to 180 ft/sec. The spheres struck a steel plate positioned three feet away from the point where initial velocity was determined, and rebounded through a speed-monitoring device located at the same point as the initial velocity measurement. The COR of each measurement was determined as the ratio of rebound velocity to initial velocity. The individually determined COR measurements were plotted as a function of initial velocity. COR at a given speed (e.g. COR₁₂₅ at 125 ft/sec) was determined by linear regression. In some cases COR measurements were made directly at 125 and 180 ft/sec (±4 ft/sec), with minor corrections to the COR data made for deviations from the target speed using accepted methods. The results are summarized in Table 7 where the Atti compression was corrected to 1.68 inches.

TABLE 7

| | Atti | COR | | |
|---|---|---|---|---|
| Example | Compression | at 125 ft/sec | at 150 ft/sec | at 180 ft/sec |
| 1 | 139 | 0.517 | 0.482 | 0.439 |
| 2 | 120 | 0.496 | 0.466 | 0.429 |
| 3 | 113 | 0.486 | 0.457 | 0.421 |
| 4 | 93 | 0.465 | 0.437 | 0.403 |
| 5 | 82 | 0.454 | 0.427 | 0.394 |
| 6 | 70 | 0.439 | 0.413 | 0.383 |
| 7 | 59 | 0.436 | 0.411 | 0.38 |
| C1 | 157 | 0.753 | 0.729 | 0.7 |
| C2 | 35 | 0.521 | 0.498 | 0.471 |
| 8 | 149 | 0.645 | 0.592 | 0.529 |
| 9 | 146 | 0.641 | 0.607 | 0.567 |
| 10 | 137 | 0.635 | 0.601 | 0.561 |
| 11 | 112 | 0.587 | 0.56 | 0.527 |
| 12 | 126 | 0.616 | 0.586 | 0.549 |
| 13 | 98 | 0.549 | 0.525 | 0.495 |
| 14 | 79 | 0.529 | 0.506 | 0.477 |
| C3 | 160 | 0.78 | 0.754 | 0.723 |
| 1A | 149 | 0.579 | 0.543 | 0.5 |
| 15 | 164 | 0.665 | 0.632 | 0.598 |
| 16 | 163 | 0.700 | 0.673 | 0.64 |
| 17 | 140 | 0.563 | 0.519 | 0.467 |
| 18 | 174 | — | cracked | cracked |
| 19 | 164 | 0.742 | 0.707 | 0.664 |

The compositions of Examples 1 through 19 are overmolded over nominal 1.55 inch commercial thermoset polybutadiene rubber cores to provide two-layer spheres with a nominal diameter of 1.64 inches. Polyurethane cover layers with a nominal 0.04 inch thickness are compression molded over the two-layer spheres to provide golf balls with a nominal diameter of 1.68 inches having a polyurethane cover, an intermediate layer of the compositions of Examples 1 through 19 and a thermoset polybutadiene rubber core. The interior of the compression mold is configured to provide a conventional dimple pattern molded into the exterior of the ball.

Similarly, cover layers comprising an ionomer or an organic acid-modified ionomer composition are compression molded over the two-layer spheres to provide golf balls with an ionomer or an organic acid-modified ionomer cover, an intermediate layer of the compositions of Examples 1 through 19 and a thermoset polybutadiene rubber core.

While certain of the preferred embodiments of this invention have been described and specifically exemplified above, it is not intended that the invention be limited to such embodiments. Various modifications may be made without departing from the scope and spirit of the invention, as set forth in the following claims.

1. A dicarboxylic acid-modified ionomer composition comprising:
(a) 59.5 to 94.5 weight %, based on the combination of (a), (b) and (c), of an E/W dipolymer, wherein E represents copolymerized units of ethylene, and W represents copolymerized units of a C₃ to C₈ α,β-ethylenically unsaturated carboxylic acid, wherein the amount of W is from about 2 to about 30 weight % of the E/W dipolymer, wherein the weight average molecular weight (Mw) of the E/W dipolymer is in the range of 80,000 to 500,000 Daltons (Da);
(b) an amount of dicarboxylic acid moiety or salt thereof, wherein the dicarboxylic acid has the formula
(i) HOOC—(CH₂)ₙ—COOH where n is an integer from 2 to 6; or
(ii) HOOC—C₆H₄—COOH;
such that dicarboxylic acid moiety, calculated as free dicarboxylic acid, is present at a level of from 0.5 to 15 weight % of the combination of (a), (b) and (c); and
(c) 5 to 40 weight %, based on the combination of (a), (b) and (c), of at least one of
(iv) an E/X/Y terpolymer, wherein E represents copolymerized units of ethylene, X represents copolymerized units of a C₃ to C₈ α,β-ethylenically unsaturated carboxylic acid, and Y represents copolymerized units of a softening comonomer selected from the group consisting of vinyl acetate, alkyl acrylate and alkyl methacrylate; wherein the alkyl groups have from 1 to 8 carbon atoms; wherein the amount of X is from about 2 to about 30 weight % of the E/X/Y terpolymer, and the amount of Y is from about 3 to about 45 weight % of the E/X/Y terpolymer; and wherein the (Mw) of the E/X/Y terpolymer is in the range of 80,000 to 500,000 Da; or
(v) an ethylene dicarboxylic random copolymer comprising copolymerized units of ethylene and copolymerized units of a dicarboxylic comonomer selected from the group consisting of cyclic anhydrides of C₄-C₈ unsaturated acids, monoesters of C₄-C₈ unsaturated acids having at least two carboxylic acid groups, diesters of C₄-C₈ unsaturated acids having at least two carboxylic acid groups, and mixtures thereof, wherein said second ethylene copolymer comprises from about 5 to about 15 weight % copolymerized units of said polar comonomer, based on the weight of the random copolymer; or
(vi) a polyolefin graft copolymer comprising a trunk polymer comprising polyethylene, polypropylene, or a copolymer copolymerized units of ethylene and copolymerized units of vinyl acetate, alkyl acrylate or alkyl methacrylate; wherein the alkyl groups have from 1 to 8 carbon atoms, wherein the trunk copolymer is modified by grafting thereto cyclic anhydrides of C₄-C₈ unsaturated acids; or
(vii) an E/Z dipolymer, wherein E represents copolymerized units of ethylene and Z represents copolymerized units of acrylic acid or methacrylic acid; wherein the amount of Z is about 3 to about 25 weight % of the E/Z copolymer; and wherein the Mw of the E/Z dipolymer in the range of 2,000 to 30,000 Da; wherein
the combined acid moieties in (a), (b) and (c) are nominally neutralized to a level from about 30% to about 75% to form carboxylate salts comprising alkali metal, alkaline earth or transition metal cations.

2. The composition of claim 1 wherein the dicarboxylic acid is adipic acid.

3. The composition of claim 1 wherein the E/W copolymer is a dipolymer of ethylene and acrylic acid or methacrylic acid.

4. The composition of claim 1 wherein the (c) component consists essentially of (c)(iv).

5. The composition of claim 1 wherein the (c) component consists essentially of (c)(v).

6. The composition of claim 1 wherein the (c) component consists essentially of (c)(vi).

7. The composition of claim 1 wherein the (c) component consists essentially of (c)(vii).

8. The composition of claim 1 wherein the (c) component comprises a mixture of (c)(iv) and (c)(vii).

9. A golf ball comprising the composition of claim 1.

10. The golf ball of claim 9 comprising a cover, a core and at least one intermediate layer between the cover and the core, wherein the intermediate layer comprises the composition.

11. The golf ball of claim 10 wherein the cover comprises a polyurethane composition, a polyurea composition, an ionomer composition or an organic acid-modified iononomer composition other than the dicarboxylic acid-modified ionomer composition.

12. The golf ball of claim 10 wherein the core comprises polybutadiene rubber.

13. The golf ball of claim 10 wherein the core comprises an organic acid-modified ionomer composition other than the dicarboxylic acid-modified ionomer composition.

14. A golf ball comprising a core, a cover, and at least one intermediate layer between the core and the cover, the intermediate layer comprising a dicarboxylic acid-modified ionomer composition comprising:
(a) 59.5 to 99.5 weight %, based on the combination of (a), (b) and (c) when present, of an E/W dipolymer, wherein E represents copolymerized units of ethylene, and W represents copolymerized units of a C₃ to C₈ α,β-ethylenically unsaturated carboxylic acid, wherein the amount of W is from about 2 to about 30 weight % of the E/W dipolymer, wherein the Mw of the E/W dipolymer is in the range of 80,000 to 500,000 Da;
(b) an amount of dicarboxylic acid moiety or salt thereof, wherein the dicarboxylic acid has the formula
(i) HOOC—(CH₂)ₙ—COOH where n is an integer from 2 to 6; or
(ii) HOOC—C₆H₄—COOH;
such that dicarboxylic acid moiety, calculated as free dicarboxylic acid, is present at a level of from 0.5 to 15 weight % of the combination of (a), (b) and (c) when present; and optionally
(c) 5 to 40 weight %, based on the combination of (a), (b) and (c) when present, of at least one of
(iv) an E/X/Y terpolymer, wherein E represents copolymerized units of ethylene, X represents copolymerized units of a C₃ to C₈ α,β-ethylenically unsaturated carboxylic acid, and Y represents copolymerized units of a softening comonomer selected from the group consisting of vinyl acetate, alkyl acrylate and alkyl methacrylate; wherein the alkyl groups have from 1 to 8 carbon atoms; wherein the amount of X is from about 2 to about 30 weight % of the E/X/Y terpolymer, and the amount of Y is from about 3 to about 45 weight % of the E/X/Y terpolymer; and wherein the weight average molecular weight (Mw) of the E/X/Y terpolymer is in the range of 80,000 to 500,000 Da; or
(v) an ethylene dicarboxylic random copolymer comprising copolymerized units of ethylene and copolymerized units of a dicarboxylic comonomer selected from the group consisting of cyclic anhydrides of C₄-C₈ unsaturated acids, monoesters of C₄-C₈ unsaturated acids having at least two carboxylic acid groups, diesters of C₄-C₈ unsaturated acids having at least two carboxylic acid groups, and mixtures thereof, wherein the ethylene dicarboxylic random copolymer comprises from about 5 to about 15 weight % copolymerized units of the dicarboxylic comonomer, based on the weight of the random copolymer; or
(vi) a polyolefin graft copolymer comprising a trunk polymer comprising polyethylene, polypropylene, or a copolymer copolymerized units of ethylene and copolymerized units of vinyl acetate, alkyl acrylate or alkyl methacrylate; wherein the alkyl groups have from 1 to 8 carbon atoms, wherein the trunk copolymer is modified by grafting thereto cyclic anhydrides of C₄-C₈ unsaturated acids; or
(vii) an E/Z dipolymer, wherein E represents copolymerized units of ethylene and Z represents copolymerized units of acrylic acid or methacrylic acid; wherein the amount of Z is about 3 to about 25 weight % of the E/Z copolymer; and wherein the Mw of the E/Z dipolymer in the range of 2,000 to 30,000 Da; wherein
the combined acid moieties in (a), (b) and (c) when present are nominally neutralized to a level from about 30% to about 75% to form carboxylate salts comprising alkali metal, alkaline earth or transition metal cations.

15. The golf ball of claim 14 wherein the dicarboxylic acid is adipic acid.

16. The golf ball of claim 14 wherein the E/W copolymer is a dipolymer of ethylene and acrylic acid or methacrylic acid.

17. The golf ball of claim 14 wherein the (c) component is present in the dicarboxylic acid-modified ionomer composition and comprises (c)(iv).

18. The golf ball of claim 14 wherein the (c) component is present in the dicarboxylic acid-modified ionomer composition and comprises (c)(v).

19. The golf ball of claim 14 wherein the (c) component is present in the dicarboxylic acid-modified ionomer composition and comprises (c)(vi).

20. The golf ball of claim 14 wherein the (c) component is present in the dicarboxylic acid-modified ionomer composition and comprises (c)(vii).

21. The golf ball of claim 14 wherein the (c) component is present in the dicarboxylic acid-modified ionomer composition and comprises (c)(iv) and (c)(vii).

22. The golf ball of claim 14 wherein the cover comprises a polyurethane composition, a polyurea composition, an ionomer composition or an organic acid-modified iononomer composition other than the dicarboxylic acid-modified ionomer composition.

23. The golf ball of claim 14 wherein the core comprises polybutadiene rubber.

24. The golf ball of claim 14 wherein the core comprises an organic acid-modified ionomer composition other than the dicarboxylic acid-modified ionomer composition.
